(19) United States
(12) Patent Application Publication
(10) Pub. No.: US 2004/0246925 A1
(43) Pub. Date: Dec. 9, 2004

(54) Method and transceiving device for transmitting information units via radio links

(76) Inventor: Yan Wang, Beijing (CN)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/483,514

(22) PCT Filed: Jul. 9, 2001
(86) PCT No.: PCT/EP01/07874

(51) Int. Cl. H04Q 7/00

(52) U.S. Cl. 370/332; 370/252

(57) ABSTRACT

In order to reduce delay and increase throughput of conventional hybrid type II automatic repeat request (ARQ) the present invention shows a method for estimating the signal to interference ratio SIR of a transmission time division duplex (TDD) channel slot to apply adapted code rates for the encoding of information units transmitted through this slot. The adapted code rates are achieved by defining a set of distinct transmission and retransmission thresholds which allow to refer to a particular code rate by taking a signal to interference ratio SIR of a timeshifted different TDD channel slot into consideration, assuming that the correlation of the conditions of the TDD channel is high enough.

### CROSS-REFERENCE TO RELATED APPLICATION

This application is the U.S. National Stage of International Application PCT/EP01/07874 filed Jul. 9, 2001 and published in the English language Jan. 23, 2003 under International Publication Number WO 03/007533 A1.

### BACKGROUND OF THE INVENTION

1. Technical Field

The present invention is related to an error handling in transmission of information units in time division duplex channels (TDD) radio links and in particular it is related to an error handling using automatic repeat request (ARQ) and to the transmission of information units in mobile communication. More particularly the invention relates to a method and transceiving device for transmitting information units via radio links using a code rate derived from an estimated signal to interference ratio.

2. Discussion of Related Art

In mobile communication, transmission is performed by using a digital modulation to impress data on carrier waves. There exists a large variety of standardized air interfaces, such as the Global System for Mobile Communication (GSM) standard specified by the European Telecommunication Standard Institute (ETSI) using time division multiple access (TDMA), while in the United States a number of interim standards such as IS-54 and IS-136 are defined.

The growing number of mobile terminal devices such as mobile phones or communicators yields a bigger demand for voice and data channels within the system of mobile communication. The increasing interference between neighbouring base stations and interference with other devices using radio links decreases the carrier to interference (C/I) or carrier to noise (C/N) ratio. Thus, the quality of mobile phone channels is highly fluctuating, so that transmission of erroneous information or information that is being corrupted during transmission is a very common phenomenon. The quota of erroneous units can be as high as 1% up to 10%.

To handle the problem of large error rates, usually a channel coding (it can be convolutional coding other than block coding) is used to introduce a redundancy to the data stream, which allows for a recognition and a possible correction of erroneous units transmitted. The definition of such a channel coding is known to every person skilled in the art, and thus a more precise discussion is omitted from the following specification. It suffices to say that an encoder adds some redundant bits and the decoder uses them to detect if there was a transmission error. The ratio between the information bits (input) and the information bits plus the redundant bits (channel coded bits) is called the code rate. The reliability of the channel code is defined by the number of data bits per coded bits ν. The higher the number of data bits per code bits ν, the less redundancy is introduced to the data stream and the less encoded (this is to differentiate “encoding” from “modulation”) information units are secured against corruption during transmission. If an erroneous unit is received, a retransmission of the data (in type II hybrid ARQ, the data can be retransmitted in another format) is necessary. Accordingly, the basic ARQ scheme provides error detection and retransmission capabilities. If an information unit is found to be corrupted during transmission, it is discarded and a retransmission of the same information unit is requested.

On the other hand a fast transmission of data other than voice channels, such as in the general packet radio service (GPRS) standard or in the upcoming universal mobile telecommunication system (UMTS) standard, is essential due to a large amount of transferred data and a limited transmission rate. The transmission rate is determined among other factors by the reliability of the transferred data. The higher the number of coded bits the poorer the transmission rate. Yet, it is important to select a large number of data bits per coded bits ν corresponding to the quality of the transmission link to ensure a fast and reliable transmission.

One commonly used scheme is the type II hybrid ARQ. In the type II hybrid ARQ scheme, information is first sent with a high code rate (for consistency, we take the code rate ⅔ as “higher” than 1/2), i.e. lesser redundancy, and if one erroneous unit is requested to be retransmitted, additional code bits will be added for the following transmission. This enhances the transmission rate of the information units. First, a rather poor coding is used and only if transmission fails due to erroneous units, a more reliable block code is used.

For example, two different types of type II hybrid ARQ schemes can be used. A set of consequent code rates defined by the number of data bits per code bits ν decreasing as 1 ½ ⅓ is used. The other one is using a finer code rate granularity. This scheme yields a code rate of ν: 1→⅔→½ ⅖→⅓. It is appreciated by a person skilled in the art, that a fine code rate granularity results in a higher link throughput but in higher normalized packet delays as well.

Therefore, it is the object of the present invention to reduce the access and transmission delay and improve the throughput of delay sensitive packet data services in a method and transceiving device for transmitting information units via radio links.

### SUMMARY OF INVENTION

According to a first aspect of the present invention, this object is achieved by a method for transmitting information units with an adaptive automatic repeat request (ARQ) code rate derived from an estimated signal to interference ratio SIRₑₛₜᵢₘₐₜᵢₒₙ ^{in radio links, comprising the steps of estimating a signal to interference ratio SIR}ₑₛₜᵢₘₐₜᵢₒₙ of a time division duplex (TDD) channel uplink slot, selecting a set of M distinct automatic repeat request (ARQ) code rates (R₁, . . . , R_{M}), selecting a set of K distinct transmission thresholds (T₁, . . . , T_{K}) with K<M, wherein the thresholds are ordered by their magnitude, selecting a transmission code rate Rᵢ_{ₒ}, according to: T_{I}_{ₒ}<SIRₑₛₜᵢₘₐₜᵢₒₙ≦T_{I}₊₁, wherein iₒ<M, and transmitting information units on a time division duplex channel downlink slot using said transmission code rate R_{I}_{ₒ}. By using the algorithm of the present invention which is an adaptive type II hybrid ARQ and using the “memory” or correlation respectively of an time division duplex (TDD) channel for estimating the channel quality and following a condition adapted transmission code, transmission errors on fading channels are prevented.

Accordingly, a method for transmitting information units in a radio link is provided using an adapted code rate to ensure the quality of service. In order to select the adapted code rate the following steps have to be carried out. In a first step the signal to interference ratio of a TDD channel uplink slot is determined in order to estimate the signal to interference ratio (SIR) of a TDD channel downlink slot. TDD channels include up- and downlink slots in one frame and a person skilled in the art knows that TDD channel slots in one frame are highly correlated relating to channel fading. Therefor, it is reasonable using the uplink slot SIR to estimate the downlink slot SIR. In a next step a set of M distinct code rates (Rᵢ, i=1, . . . , M) and a set of K distinct transmission thresholds (Tⱼ, j=1, . . . , K; K<M) are selected. Said transmission thresholds are ordered by their magnitude. By using said estimated SIR and said set of transmission thresholds in a last step a respective code rate for transmitting information units on the TDD downlink slot is provided out of said set of code rates. An index i₀ is determined according to T_{I}_{₀}<SIR≦T_{I}_{₀}₊₁ wherein i₀<M. Said index i₀ refers to a code rate R_{I}_{₀} out of said set of code rates used for the condition adapted first transmission.

In a preferred embodiment, the method of the present invention uses type II hybrid automatic repeat request (ARQ) code rates for said set of code rates e.g. according to given code rates used for wireless communication systems.

Additionally, said set of code rates is ordered by the number of data bits per coded bits. In combination with said above by magnitude ordered transmission thresholds the method of the present invention describes a procedure of increasing the reliability of transmission the more the estimated SIR of the channel gets lower or the worse the TDD channel conditions become. Contrary to known correction methods, reliable code rates are used before transmitting errors occur, not only when retransmission is necessary, and therefore the total transmission rate is enhanced.

In another preferred embodiment of the present invention, the method of selecting code rates is extended to retransmission of erroneous information units. In the same way as the above described method of determining a code rate for transmitting information units, the determination of a code rate for retransmitting comprises the following steps. A set of G distinct retransmission thresholds (TRₖ, k=1, . . . , G; G<M) is selected. A further index i₁ is determined according to TR_{I}_{₁}<SIR≦TR_{I}_{₁}₊₁ wherein i₀+i₁<M. The retransmission of previously transmitted erroneous information units is using a retransmission code rate R_{I}_{₀}_{+I}_{₁}. The transmission code rate and therefore the condition of the TDD channel is taken into consideration using a retransmission code rate like that described above.

In conditions that are bad for using radio links, it can be possible that the retransmission of erroneous information units still includes erroneous units. In this case, the method of determining a code rate for further retransmission is continued in the same way. On the assumption that a n−1^{th} retransmissions includes erroneous information units, the code rate for the n^{th} retransmission is derived once again from the code rate of the n−1^{th} retransmission R_{I}_{₀}_{I}_{₁}₊_{_{—}}_{+I}_{ₙ₋₁} in and according to TR_{I}_{ₙ}<SIR≦TRᵢ_{ₙ}₊₁ wherein i_{O}+i₁+ . . . +iₙ<M. Retransmission is using the code rate R_{I}_{₀}_{+I}_{₁}_{+ . . . +I}_{ₙ}.

A further embodiment of the present invention adapts to changing conditions by determining said signal to interference ratio SIR each time a TDD channel uplink slot is used, in order to apply a current SIR value for the downlink slot estimation and to determine current transmission/retransmission code rates. If conditions change fast which is often possible while using radio links in vehicles it is additionally advantageous to determine not only said signal to interference ratio SIR but also to select anew said set of transmission thresholds and said set of retransmission thresholds in order to adapt these values to the link conditions.

Fast transmission of data is often achievable not only by using single TDD channel uplink and downlink slots. Therefore it could be necessary to use more slots of a TDD channel for uplink or downlink respectively to transfer delay sensitive data just in time. The described method of the present invention can be expanded using several slots for which the estimation of the code rate is achieved according to the presented algorithm. Nevertheless radio linking is today not only done unidirectionally. Most radio links are established by transceivers which exchange data in both directions which means in uplink and downlink. The described method of the present invention can also be applied in the same way for transmitting/retransmitting data on a TDD channel uplink slot obtaining said signal to interference ratio SIR from the TDD channel downlink slot.

According to another aspect of the present invention, a computer program product is provided, comprising program code means stored on a computer readable medium for performing the method for retransmitting erroneous information units using a type II ARQ scheme. By using a computer program for the execution of the method for retransmitting erroneous information units using a type II ARQ scheme, the method can easily be implemented in a computer or terminal device.

According to yet another aspect of the present invention, a computer program product is provided, comprising program code means stored on a computer readable medium for performing the method of any of the method claims when the program product is run on a computer or terminal device.

According to still another aspect of the present invention, a transceiving device is provided, comprising means for transceiving information units, means for detecting erroneous units, that have been corrupted during transmission, means for requesting a retransmission of the erroneous units, means for receiving a retransmission request, means for determining a signal to interference ratio SIR, means for decoding/encoding transmitted/retransmitted information units using a set of selected code ratings derived from a signal to interference ratio SIR and said set of transmission/retransmission thresholds according to the algorithm of the present invention.

Since communication is always going in both directions, a device taking part in communication transmits as well as it receives information units. It decodes and checks every information unit, if it is received with error or not. Thus it selects all erroneous units that have been corrupted during transmission and can not be corrected by help of the redundancy of a code rate used for modulation before transmission. If erroneous units are received, a retransmission request is sent, requesting for a retransmission of those units, until no more erroneous units are found. The same device is used on the other hand to transmit information units. Those information units are first encoded by a set of selected code rates and than transmitted by the transceiving means. If a retransmission request is received, indicating that a subset of the transmitted information had been received by another transceiving device with error, those erroneous units are selected and encoded anew with a different set of code rates, selected according to the previously described method, before being retransmitted.

The transceiving device may be a terminal device, preferably a mobile terminal device or it may be a mobile communication access point. Examples for those transceiving devices are mobile phones or base stations in a mobile communication system. Yet, it will be appreciated, that other transceiving devices may be thought of, such as satellites or computers and other devices, linked by wireless connection, such as bluetooth, infrared (IR) or radio relay systems.

According to still yet another aspect of the present invention, a communication network is provided, comprising at least one transceiving device and at least one access point in communication for the transceiving device and forming part of a network. A communication network thus consists of at least two transceiving devices, one being the communication access point. Preferably, the communication network according the present invention further comprises a server, where the server is coupled to another network, and advantageously, at least one network is a mobile communication network. The network is preferably the Internet.

### BRIEF DESCRIPTION OF THE DRAWINGS

A more complete appreciation of the invention and many other attendant advantages thereof will be readily obtained, as the same becomes better understood by reference to the following detailed description when considered in connection with the accompanying drawings, wherein:

FIG. 1 shows a schematic diagram of a time division duplex (TDD) channel and the affiliated channel slots used for uplinking and downlinking,

FIG. 2 shows a schematic view of the chronological sequence of the method for transmitting/retransmitting information units on a TDD channel according to the method of the present invention,

FIG. 3 shows the first two cases of an example according to the method of the present invention using specific values to demonstrate the algorithm and

FIG. 4 shows the following two cases of an example according to the method of the present invention using specific values to demonstrate the algorithm.

### DETAILED DESCRIPTION OF THE INVENTION

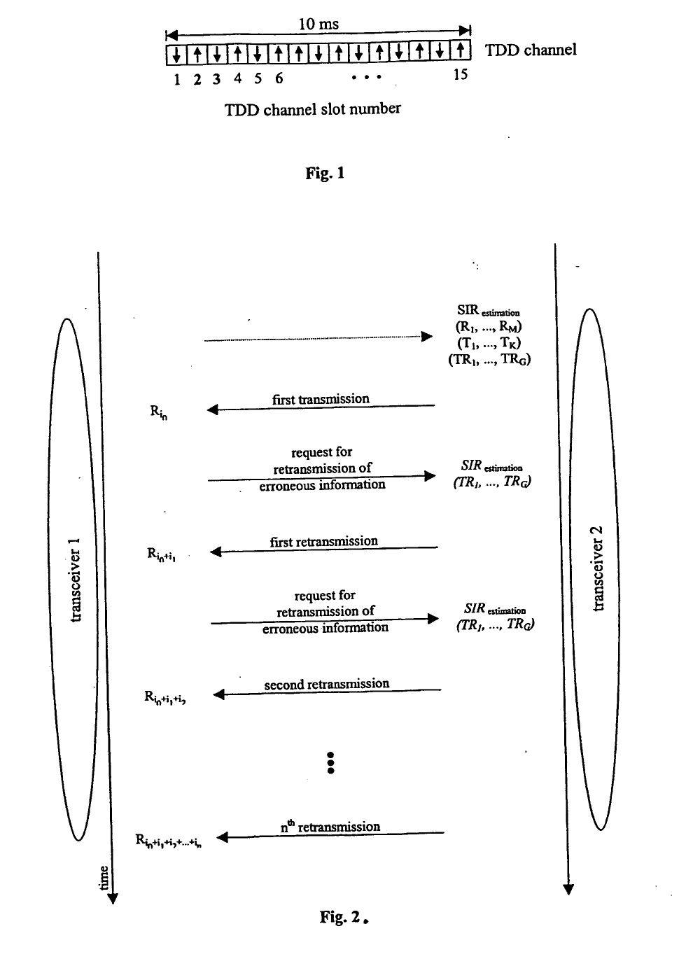

FIG. 1 shows a typical setup of a TDD channel with 15 designated slots within a 10 ms time frame. TDD channels are well known to persons skilled in the art. Both uplink and downlink slots are assigned to transceivers which participate in the information unit broadcast. Both uplink and downlink slots using the same frequency are only separated by time shifting. Channel fading is a well known phenomenon which is highly frequency dependant. Therefore TDD channel slot conditions are also highly correlated in fading conditions and a signal to interference ratio of a slot can be used to estimate the signal to interference ratios of the other slots since the fading conditions do not vary in time too fast.

The essential proceedings for transmitting and retransmitting information units between a transceiver 1 and a transceiver 2 according to the method of the present invention are shown in FIG. 2. Before starting a transmission for data on a TDD channel to transceiver 1 the signal to interference ratio SIR of the TDD channel is estimated. In combination with the set of selected code rates which can be defined by the radio link standard and a set of adapted corresponding transmission and retransmission thresholds a specific adapted code rate for encoding of the first transmission is determined using the algorithm of the present invention. If erroneous information units occur after encoding of the transmitted information units a request for retransmitting the erroneous information units is transmitted from transceiver 1 to transceiver 2. The erroneous information units are prepared anew for retransmitting using again the algorithm of the present invention for selecting a code rate for the first retransmission. Dependant on period of the proceeding and link conditions the estimated signal to interference ratio SIR can be determined anew and a new set of selected retransmission thresholds can be set up. As a consequence, retransmission is carried out with an improved code rate to increase the redundancy of the information units to enhance the reliability of the retransmission in comparison to the transmission carried out before. If subsequent retransmissions are necessary the determination of the applied code rates are established in the same way. The redundancy of the contents of the retransmitted information units is always increased further to enhance the reliability of the retransmission until no erroneous information units are detected any more.

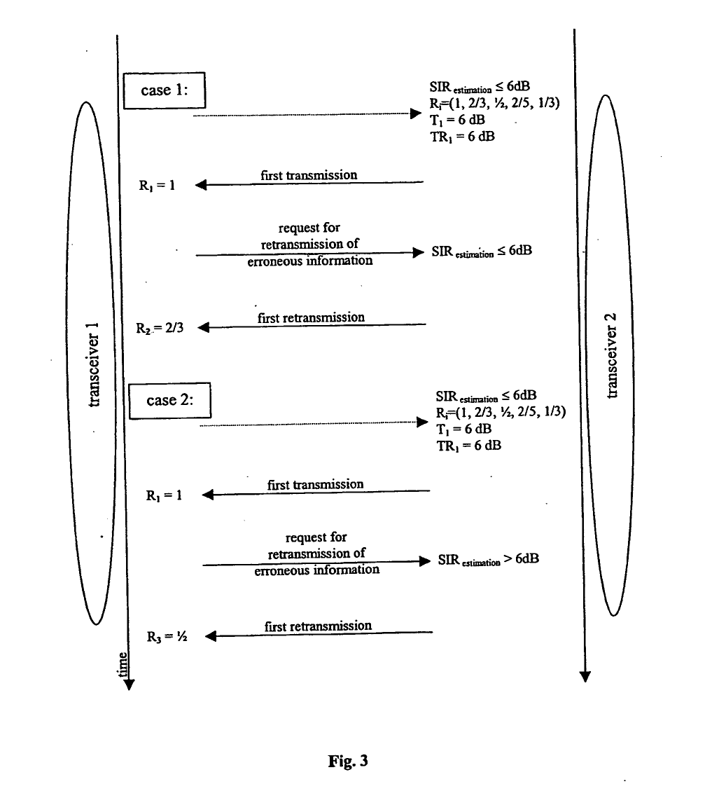

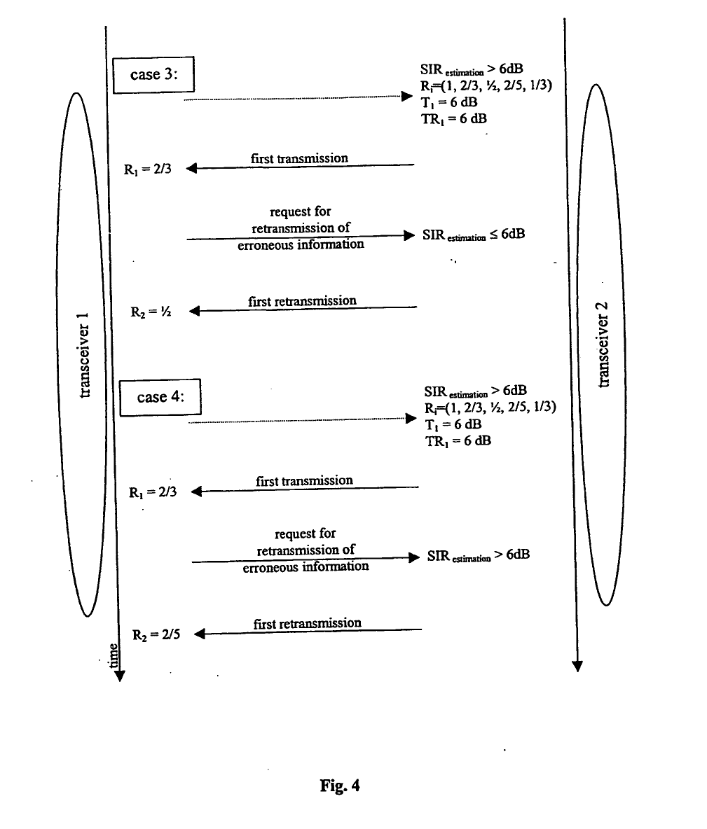

An example with specific values for signal to interference ratio, code rates and thresholds is shown in FIG. 3 and FIG. 4 to illustrate the proceeding of transmission and retransmission according to the method of the present invention.

In the first case (see FIG. 3) the signal to interference ratio SIR shall be below 6 dB, the set of code rates (R₁=(1, ⅔, ½, ⅖, ⅓)) is chosen and both the transmission and retransmission threshold are set to 6 dB. Using the method of the present invention a first transmission would be carried out applying R₁=1 to encode the transmitted information units. A first retransmission of erroneous information units is assumed. A new determination of the signal to interference ratio still shows a value below 6 dB. According to the method of the present invention the index referring to said code rate is decreased by one step so that the retransmission is carried out applying R₂=⅔ to encode the retransmitted information units.

In the second case assumptions and a set up in the beginning are equal to case 1 and therefore code rate used for the first transmission is the same. After requesting of erroneous information units a signal to interference ratio over 6 dB is determined and used for the code rating estimation. Following the method of the present invention the index referring to said code rating is decreased by more than one step so that the code rate R₃=½ is applied for encoding the retransmitted information units.

In cases 3 and 4 (see FIG. 4) the initial signal to interference value is assumed to be above 6 dB while the remaining values and set up is the same as cases 1 and 2. This leads to a first transmitting code rate R₂=⅔. In case 3 the signal to interference ratio is below 6 dB determined for the estimation of the retransmission slot the index referring to said code rate is decreased by one step so that the retransmission is carried out applying R₃=½ to encode the retransmitted information units whereas in case 4 the signal to interference ratio is assumed to be over 6 dB the index referring to said code rate is decreased by more than one step so that the retransmission is carried out applying R₄=⅖ to encode the retransmitted information units.

This specification contains the description of implementations and embodiments of the present invention with the help of examples. It will be appreciated by a person skilled in the art, that the present invention is not restricted to details of the embodiments presented above, and that the invention can also be implemented in another form without deviating from the characteristics of the invention. The embodiments presented above should be considered as illustrative, but not restricting. Thus, the possibilities of implementing and using the invention are only restricted by the enclosed claims. Consequently, various options of implementing the invention as determined by the claims, including equivalent implementations, also belong to the scope of the invention.

1. Method for transmitting information units with an adaptive automatic repeat request (ARQ) code rate derived from an estimated signal to interference ratio SIRₑₛₜᵢₘₐₜᵢₒₙ in radio links, comprising the steps of:
estimating a signal to interference ratio SIRₑₛₜᵢₘₐₜᵢₒₙ of a time division duplex (TDD) channel uplink slot,
selecting a set of M distinct automatic repeat request (ARQ) code rates (R₁, . . . R_{M}),
selecting a set of K distinct transmission thresholds (T₁, . . . T_{K}) with K<M, wherein the thresholds are ordered by their magnitude,
selecting a transmission code rate R₁₀, according to:
Tᵢ₀<SIRₑₛₜᵢₘₐₜᵢₒₙ≦Tᵢ₀₊₁, wherein i₀<M, and
transmitting information units on a time division duplex channel downlink slot using said transmission code rate Rᵢ₀.

2. Method according to claim 1, wherein said M distinct coding rates (R₁, . . . , R_{M}) are ordered by a number of data bits per coded bits.

3. Method according to claim 1, wherein a first retransmission of erroneous information is requested using a first retransmission code rate derived from said transmission code rate Rᵢ₀ and a new set of thresholds, comprising the steps of:
selecting a set of G distinct retransmission thresholds (TR₁, . . . , T_{R}_{G}) with G<M, where the thresholds are ordered by magnitude,
selecting the retransmission code rate Rᵢₒ₊ᵢ₁, according to:
TRᵢ₁<SIRₑₛₜᵢₘₐₜᵢₒₙ≦TRᵢ₁₊₁, wherein i₀+i₁<M and i₁<G,
retransmitting said erroneous information units in said time division duplex channel downlink slot using said code rate Rᵢₒ₊ᵢ₁.

4. Method according to claim 3, wherein an n^{th} retransmission of the erroneous information is requested using an n^{th} retransmission code rate derived from said retransmission code rate R_{io+i1+ . . . +in-1}, comprising the steps of:
selecting the retransmission coding rate R_{io+i1+ . . . +in}, according to:
TRᵢₙ<SIRₑₛₜᵢₘₐₜᵢₒₙ≦TRᵢₙ₊₁, wherein i₀+i₁+ . . . +iₙ<M and iₙ<G
retransmitting said erroneous information in said time division duplex channel downlink slot using said coding rate R_{io+i1+ . . . +i1++in}.

5. Method according to claim 1, where said signal to interference ratio SIRₑₛₜᵢₘₐₜᵢₒₙ is estimated each time said time division duplex channel uplink slot is used and/or before said signal to interference ratio SIRₑₛₜᵢₘₐₜᵢₒₙ is used to determine said transmission/retransmission code rate.

6. Method according to claim 3, where said set of K distinct transmission thresholds (T₁, . . . , T_{K}) and/or said set of G distinct retransmission thresholds (TR₁, . . . , TR_{G}) can be selected anew each time transmission/retransmission is carried out.

7. Method according to claim 1, where more than one time division duplex channel uplink slot and/or time division duplex channel downlink slot are used for transmission and/or retransmission, wherein the method is applied in the same way.

8. Method according to claim 1, where a signal to interference ratio is estimated by a time division duplex channel downlink slot and a transmission/retransmission of information units is carried out on a time division duplex channel uplink slot.

9. Computer program product comprising program code means stored on a computer readable medium for performing the method of claim 1 when said program product is run on a computer.

10. Computer program product comprising program code means stored on a computer readable medium for performing the method of claim 1 when said program product is run on a computer or terminal device.

11. Transceiving device adapted to perform the method according to claim 1, comprising:
means for determining a signal to interference ratio SIR of a time division duplex channel uplink and/or downlink slots;
means for selecting M distinct code rates;
means for selecting a set of K distinct transmission thresholds;
means for decoding and/or encoding said information units according to said transmission/retransmission code rate;
means for transceiving a retransmission request; and
means for transceiving information units.

12. Transceiving device according to claim 11, where said transceiving device is a terminal device.

13. Transceiving device according to claim 12, where said transceiving device is a mobile terminal device.

14. Transceiving device according to claim 13, where said transceiving device is a mobile communication access point.
